(19) United States
(12) Patent Application Publication
(10) Pub. No.: US 2017/0316035 A1
(43) Pub. Date: Nov. 2, 2017

(54) RULE-GOVERNED ENTITLEMENT DATA STRUCTURE CHANGE NOTIFICATIONS

(71) Applicant: Microsoft Technology Licensing, LLC, Redmond, WA (US)

(72) Inventors: Lyubomir G. Karadashkov, Boston, MA (US); Saurabh D. Mehta, Watertown, MA (US); Timothy H. Eshelman, Arlington, MA (US)

(73) Assignee: Microsoft Technology Licensing, LLC, Redmond, WA (US)

(21) Appl. No.: 15/140,383

(22) Filed: Apr. 27, 2016

(51) Int. Cl. G06F 17/30; H04L 29/08; G06F 9/54

(52) U.S. Cl. CPC G06F 17/30289; G06F 9/542; H04L 67/306

(57) ABSTRACT

A notification computer system can retrieve an event data element from a queue in an entitlement computer system. The event data element can represent a change to an entitlement record of a profile's entitlement to a computer service. The notification system can process the event data element, which can include accessing and applying a computer-readable rule data structure that governs processing of events from the event queue. The processing can also include generating a notification in a manner dictated by the rule data structure, with the notification indicating the change to the data structure represented by the event data element. The processing of the event data element may also include sending the notification to an entitled profile whose entitlement to a computer service is represented by the entitlement data structure.

### BACKGROUND

When computer systems provide services to which computer-readable profiles are entitled, computer systems often maintain computer-readable entitlement records in entitlement data structures, such as files or database records. Such a computer-readable entitlement record defines terms of the services to be provided to a profile, such as what computer services are to be provided, the time period for which the services are to be provided to the profile, and/or the current status of the entitlement (active, suspended, cancelled, etc.). Notifications of changes to computer-readable entitlement records in entitlement data structures have been generated in computer systems where the entitlement data structures are maintained. For example, a computer system may generate and send a notification in the form of an email notification to the entitled profile when an entitlement is activated, when an entitlement is about to be deactivated (so that the subject services will no longer be provided to that user profile), or when an entitlement has been deactivated.

### SUMMARY

Tools and techniques discussed herein relate to processing events representing changes to an entitlement data structure. The events can be processed according to a rule data structure in a different computer system from where the entitlement data structure is maintained, to determine how notifications for each event are to be handled. The processing can allow notices to be produced that comply with the rule data structure, which may incorporate preferences for intelligent rule-based handling of the events and notifications. The handling of the events for entitlement data structure changes may include the use of an event queue, as will be discussed more below. Also, a computer system may apply the rule data structure to events from multiple different computer systems, which may include events other than those representing entitlement data structure changes.

In one aspect, the tools and techniques can include a notification computer system retrieving an event data element from a queue in an entitlement computer system. The event data element can represent a change to an entitlement record of a profile's entitlement to a computer service. The notification system can process the event data element, which can include accessing and applying a computer-readable rule data structure that governs processing of events from the event queue. The processing can also include generating a notification in a manner dictated by the rule data structure, with the notification indicating the change to the data structure represented by the event data element. The processing of the event data element may also include sending the notification to an entitled profile whose entitlement to a computer service is represented by the entitlement data structure.

In another aspect of the tools and techniques, acts can be performed via a notification computer system. The acts can include event data elements being received from source computer systems that are separate from the notification computer system and from each other, and the source computer systems can include an entitlement computer system. In response to the receiving of each event data element, the acts can include processing the event data element according to a computer-readable rule data structure that governs the processing of the event data elements. Each event data element can indicate a change to a data structure represented by the event data element. One of the event data elements can represent a change to a computer-readable entitlement record in an entitlement data structure in the entitlement computer system. The processing of the event data elements can include the following for each event data element: accessing the computer-readable rule data structure; applying the computer-readable rule data structure to the event data element; generating a response to the event data element dictated by the rule data structure; and sending the response.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is a schematic diagram of a primary change notification computer system.

FIG. 3 is a schematic diagram providing additional details of a notification computer system, which may be utilized in the primary change notification computer system of FIG. 2.

FIG. 4 is a flowchart of a rule-governed entitlement data structure change notification technique.

FIG. 5 is a flowchart of another rule-governed entitlement data structure change notification technique.

### DETAILED DESCRIPTION

Aspects described herein are directed to techniques and tools related to improved notifications of changes to data structures such as entitlement data structures that include records of entitlements of computer-readable profiles to computer services. Such improvements may result from the use of various techniques and tools separately or in combination.

As an example of such techniques and tools, an online computer service may include a bundle of sub-services that are provided, such as email hosting services, online storage services, Website hosting services, services for supporting and/or enabling the use of downloadable computer applications, and other services. An entitlement can entitle a computer-readable profile (such as a user profile and/or entity profile (such as a company profile)) to use such computer services. In an example system, a change to a profile's entitlement to a service can be published as an event in an event queue. The change can be a lifecycle change, which can affect whether the entitled profile is entitled to the services, such as an activation of the entitlement, a cancellation of the entitlement, a suspension of the entitlement, or an expiration of the entitlement. One or more computer processes, such as multi-threaded processes, can detect, retrieve, and process the events, including applying event processing rules in a governing rule data structure. The rules can govern the processing of the change events, such as by specifying whether to send notifications of changes, when to send notifications of changes, and/or what types of notifications to send (such as email notifications, alerts in computer applications, text messages, and/or requesting proactive reach-out by customer service personnel) for particular events.

The rules can specify different processing for different types of events, and the rules can be personalized to a particular entitled profile to whom notifications will be sent. For example, if an event indicates an entitlement was cancelled in response to user input from the entitled profile, then rules may dictate that only a single confirmation notification is to be sent in real time after the cancellation. However, for an entitlement that expired from non-renewal, the rules may dictate that multiple follow-up notifications are to be sent to the entitled profile. As another example, the rules may dictate that for one entitled profile, notifications are to be sent in the form of emails addressed to two different sub-profiles for the entitled profile (such as user profiles of personnel who are technology managers at a company to whom the entitled profile belongs or represents). Other rules may dictate that for another entitled profile, a single text message is to be sent to a specified mobile telephone number for each notification.

Such rules may be maintained in a different computer system from a computer system where the entitlement data structures are maintained. For example, the entitlement data structures may be maintained in a commerce computer system that oversees processing of payment of subscription fees for the entitlements, while the computer system that processes the event elements and sends the notifications (the notification computer system) may be a separate computer system, such as a computer system more closely associated with the providing of the computer services that are the subject of the entitlements. For example, these different computer systems may each be running on a different set of real or virtual machines from each other. However, the notification system may still detect events being inserted into a queue of the entitlement computer system in real time by monitoring the queue.

Accordingly, a computer system can provide real-time reading and processing of published entitlement-change events from an entitlement computer system as the events become available in, such as by appearing in an accessible queue of events. As used herein, real-time refers to a response to an item occurring within ten minutes, although such responses may be quicker, such as within five minutes, within two minutes, within one minute, or within thirty seconds. This processing of events can be governed by processing rules to determine whether to notify entitled profiles. For example, a profile may be notified to inform the profile that an action needs to be taken (e.g., a payment made, etc.) in order to keep their entitlements to computer a computer service active and in good standing. As other examples, the events related to changes in entitlements may be used to trigger notifications for marketing purposes, such as customer retention, upselling, and customer continuity of business. Thus, the processing rules can govern the processing of entitlement changes and resulting notifications in real time, and this can involve multiple different types of notifications that may be used as combinations or alternatives. As a result of applying the processing rules to the entitlement change events, smart notifications can be provided that are tailored to a particular situation.

Also, an architecture for the notification system can be scalable. For example, multiple threads can be involved in retrieving and/or processing events that represent changes to entitlements. Additionally, the system can be a multi-tier system, and the system can be configured to apply the processing rules to events from multiple different source computer systems.

In at least some prior systems for processing events representing changes to entitlements, the notifications of such changes have been processed by the same computer system that made the changes to the entitlements. Such a system can be inefficient and too inflexible in many situations, such as if a different computer system is managed by administrative users who are more knowledgeable about how the notifications should be handled than the users of the entitlement systems. In such a situation, the previous systems could create a gap between system administrators who are knowledgeable about how notifications should be handled, and the system that is actually performing the processing of the notifications. This can result in unnecessary use of computer resources for communications across computer systems, slow responses when the manner of processing the notifications of changed entitlements is to be changed, or even miscommunications that may result in improper handling of the notifications of changes by the computer systems.

Accordingly, the tools and techniques discussed herein can result in an improved computer system with improved efficiency in managing and performing the processing of notifications of changes to entitlement records. Such efficiencies may result from the different features herein alone or in combination. For example, the entitlement change notification processing features discussed herein can include tools and techniques for a notification computer system to efficiently retrieve and process events for changes to entitlement records and/or other data structures, and the processing can be performed according to processing rules. This can allow for efficient and consistent processing of change notifications, even where the notifications are processed by a different computer system than a system where the changes to entitlement records are actually made. As another example, a notification computer system may apply a single set of processing rules to notifications of changes from a variety of different computer systems (where some of the changes may be changes to entitlements and others may be different types of changes), which can improve an overall computer system (which may include one or more of the different computer systems discussed above) by improving consistency and efficiency of managing and executing processing of notifications of changes to data structure states, such as changes to entitlements of profiles to computer services. Accordingly, the tools and techniques discussed herein can result in an improved computer system.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

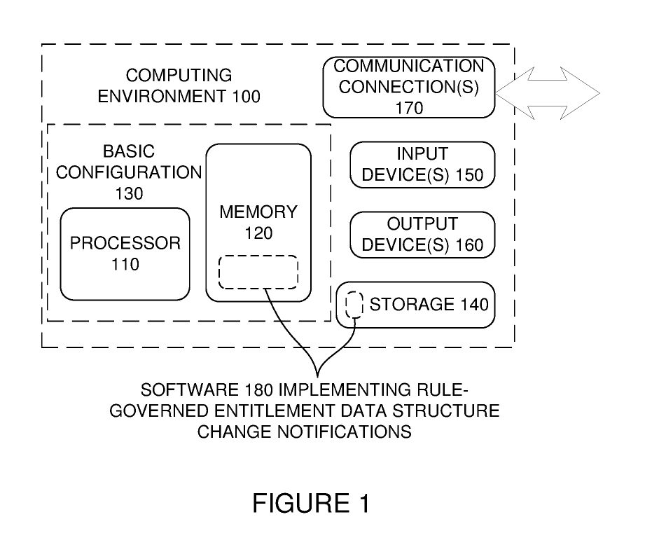

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionality, as described herein.

Implementations herein may involve the storage, sending, and/or use of personal information of users whose profiles are maintained and used in the computer systems. The computer systems can implement appropriate protections for such information. For example, such protections could include sending and/or storing such information in encrypted form, requiring and verifying appropriate credentials for accessing such information, limiting physical access to computer systems, and so forth. Moreover, consent can be obtained for storing and/or using such information. Such consent can be informed by providing documentation of ways in which the personal information is handled. For example, the consent can include opt-in and/or opt-out techniques.

### I. Exemplary Computing Environment

FIG. 1 illustrates a generalized example of a suitable computing environment 100 in which one or more of the described aspects may be implemented. For example, one or more such computing environments can be used as a computing machine in an entitlement computer system, a notification computer system, or another computer system, as discussed herein. Generally, various different computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment 100 is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment 100 includes at least one processing unit or processor 110 and memory 120. In FIG. 1, this most basic configuration 130 is included within a dashed line. The processing unit 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory), or some combination of the two. The memory 120 stores software 180 implementing rule-governed entitlement data structure change notifications. An implementation of rule-governed entitlement data structure change notifications may involve all or part of the activities of the processor 110 and memory 120 being embodied in hardware logic as an alternative to or in addition to the software 180.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment 100 may have additional features. In FIG. 1, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The memory 120 can include storage 140 (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment 100. The storage 140 stores instructions for the software 180.

The input device(s) 150 may be one or more of various different input devices. For example, the input device(s) 150 may include a user device such as a mouse, keyboard, trackball, etc. The input device(s) 150 may implement one or more natural user interface techniques, such as speech recognition, touch and stylus recognition, recognition of gestures in contact with the input device(s) 150 and adjacent to the input device(s) 150, recognition of air gestures, head and eye tracking, voice and speech recognition, sensing user brain activity (e.g., using EEG and related methods), and machine intelligence (e.g., using machine intelligence to understand user intentions and goals). As other examples, the input device(s) 150 may include a scanning device; a network adapter; a CD/DVD reader; or another device that provides input to the computing environment 100. The output device(s) 160 may be a display, printer, speaker, CD/DVD-writer, network adapter, or another device that provides output from the computing environment 100. The input device(s) 150 and output device(s) 160 may be incorporated in a single system or device, such as a touch screen or a virtual reality system.

The communication connection(s) 170 enable communication over a communication medium to another computing entity. Additionally, functionality of the components of the computing environment 100 may be implemented in a single computing machine or in multiple computing machines that are able to communicate over communication connections. Thus, the computing environment 100 may operate in a networked environment using logical connections to one or more remote computing devices, such as a handheld computing device, a personal computer, a server, a router, a network PC, a peer device or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment 100, computer-readable storage media include memory 120, storage 140, and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level abstractions for operations performed by a computer, and should not be confused with acts performed by a human being, unless performance of an act by a human being (such as a “user”) is explicitly noted. The actual computer operations corresponding to these terms vary depending on the implementation.

### II. System for Rule-Governed Entitlement

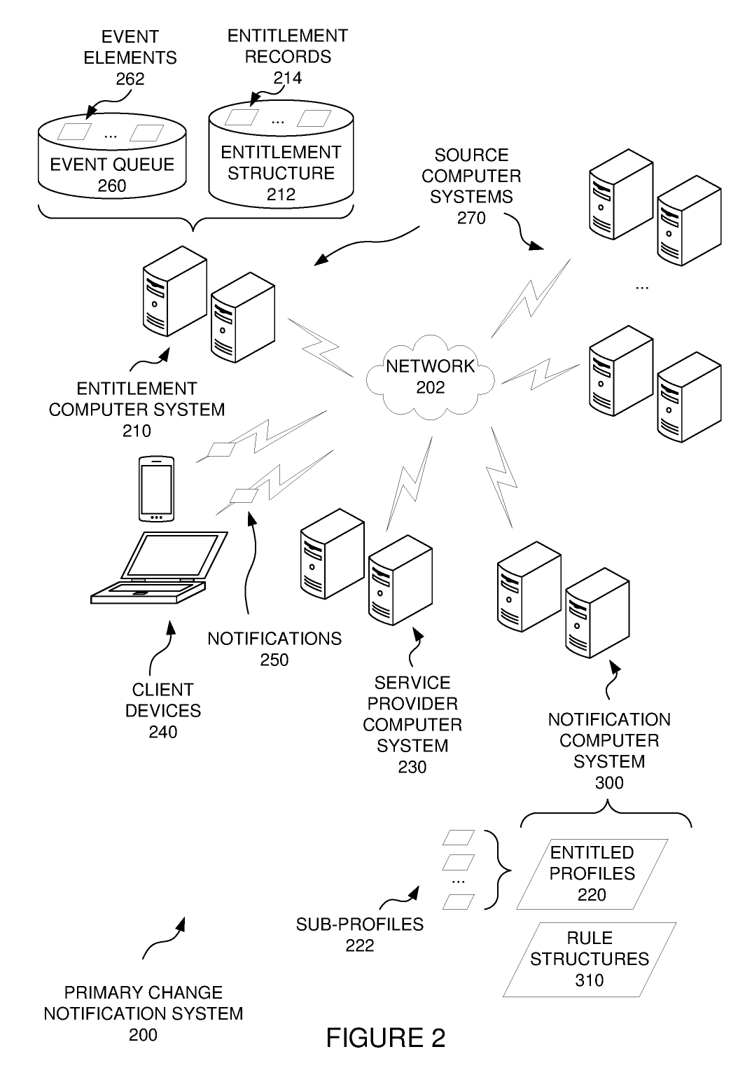

Data Structure State Change Notifications FIG. 2 is a block diagram of primary (primary in the sense that it includes one or more computer systems in the primary computer system) entitlement change notification computer system 200 in conjunction with which one or more of the described aspects may be implemented. The primary computer system 200 can include multiple separate computer systems and computer components within the primary computer system 200.

Communications between the various systems and components discussed herein can be sent using computer system hardware, such as hardware within a single computing device, hardware in multiple computing devices, and/or hardware in a computer network 202. While a network is shown between different systems in FIG. 2, communications within a particular system or sub-system may also be made over one or more computer networks. For example, a particular system may be distributed across computing machines in several different geographical locations, with the computing machines communicating over a computer network. A communication or data item may be considered to be sent to a destination by a component if that component passes the communication or data item to the system in a manner that directs the system to route the item or communication to the destination, such as by including an appropriate identifier or address associated with the destination. Such a destination may be an identified hardware component or set of hardware components, or it may be a destination data component that is stored in a hardware component. For example, a communication may be sent to a computer-readable profile if the communication is directed to an address (such as an identifier for the profile, an email address for the profile, a telephone number for the profile, an IP address where the profile is currently logged in, etc.) for that profile. Additionally, a communication may be sent to an overall profile by sending the communication to a sub-profile or associated different profile that is designated to accept communications for the overall profile. Also, a data item may be sent in multiple ways, such as by directly sending the item or by sending a notification that includes an address or pointer for use by the receiver to access the data item. In addition, multiple requests may be sent by sending a single request that requests performance of multiple tasks.

Referring still to FIG. 2, components of the primary entitlement change notification system 200 will be discussed. Each of the components includes hardware, and may also include software. For example, a component of FIG. 2 can be implemented entirely in computer hardware, such as in a system on a chip configuration. Alternatively, a component can be implemented in computer hardware that is configured according to computer software and running the computer software. The components can be distributed across computing machines or grouped into a single computing machine in various different ways. For example, a single component may be distributed across multiple different computing machines (e.g., with some of the operations of the component being performed on one or more client computing devices and other operations of the component being performed on one or more machines of a server).

The primary system 200 can include an entitlement computer system 210. As with the other computer systems of FIG. 2 discussed below, the entitlement computer system 210 may be operating on a single computing device, or it may be distributed over multiple computing devices, such as multiple computing devices in a single computing cluster or multiple computing clusters. The entitlement computer system 210 can host a computer-readable entitlement data structure 212, which can include multiple entitlement records 214. The entitlement data structure 212 may take any of various different forms, such as a database with the entitlement records 214 each forming a discrete portion of the database (tables, rows, columns, records, etc.), one or more computer-readable files that each includes a single entitlement record 214 or multiple entitlement records 214, or some other form that is readable by the entitlement computer system 210.

Each entitlement record 214 can include data that indicates a computer-readable entitled profile 220 is entitled to receive computer services from one or more service provider computer systems 230. For example, a service provider computer system 230 may provide computer services to an entitled profile 220 that is active on one or more client computer devices 240, with data being sent between the service provider computer system 230 and the client computer device(s) 240.

Each entitled profile 220 is a data structure that includes profile data, which may include sub-profiles 222 for the entitled profile 220. For example, the sub-profiles 222 may be user or group profiles for users or groups of users within a company or other organization of users, and the entitled profile 220 may be a profile for the organization itself. Each entitled profile 220 can include contact information and possibly other particularized information for the overall entitled profile 220 and/or for sub-profiles 222.

Each entitled profile 220 may also include data indicating particular services to which particular sub-profiles 222 are entitled. For example, an entitlement record 214 for an entitled profile 220 may indicate that the entitled profile is entitled to receive services for the next twelve months for fifty sub-profiles 222 to receive services A, B, and C, and for twenty sub-profiles 222 to receive services A, B, C, D, and E. That entitled profile 220 may be provisioned with such entitlements to services that are recorded in the authoritative entitlement record 214. Additionally, the entitled profile 220 may include the particular sub-profiles 222 and/or indicate which particular sub-profiles 222 are entitled to which particular services. The entitled profile 220 may also indicate which particular sub-profiles 222 are entitled to perform administrative operations for the entitled profile 220, such as which sub-profiles 222 have permissions to receive notifications regarding changes to the entitled profile's entitlement record 214, and which sub-profiles 222 have permissions to enter notification preferences for the entitled profile 220. Accordingly, notifications 250 to the entitled profile 220 may be sent to one or more sub-profiles 222 that are specified to receive such notifications according to the entitled profile 220 on client computer devices 240.

Referring still to FIG. 2, the entitlement computer system 210 can make changes to the entitlement records. For example, such changes may be lifecycle changes, which define the lifecycle of the corresponding entitlement. Examples of such changes can include changes so that an entitlement record 214 indicates that an entitlement to services is activated, cancelled, or expired. The entitlement computer system 210 can detect such changes, and may also detect warning times prior to an automatic change being made to an entitlement record 214 (e.g., one month prior to the expiration of an entitlement in an entitlement record 214). Additionally, the entitlement computer system 210 may detect anniversary times after changes have been made (e.g., ten days after activation of an entitlement in an entitlement record 214). For example, the entitlement computer system 210 may periodically run a parsing operation on the entitlement records 214 to detect changes, warning dates, and/or anniversary dates.

The entitlement computer system 210 may also automatically detect changes to the entitlement records 214 as those changes are made. For example, as part of the entitlement computer system 210 performing a data transaction that changes an entitlement record, the entitlement system may access an event queue 260 and insert an event element 262 in the event queue 260 representing the change that has been made. The event element 262 can include information identifying the entitlement record 214 that was changed, indicate the change that was made, and possibly include other information such as the time of the change, the identity of the entitled profile 220 for the changed entitlement record 214, information about notifications that may be expected as a result of the change, and so forth.

In addition to the entitlement computer system 210, other source computer systems 270 may also provide event elements 262, such as by placing such event elements 262 in queues to be provided, actively sending the event elements 262, or providing the event elements 262 some other manner. The other source computer systems 270 may provide different operations from the entitlement computer system 210. However, those operations may still relate to the entitlement record 214, such as by relating to the entitled computer services to be provided by the service provider computer system 230.

Referring still to FIG. 2, the primary system 200 can further include a notification computer system 300. The notification computer system 300 can retrieve the event elements 262 from the event queue 260 of the entitlement computer system 210. In response to retrieving an event element 262, the notification computer system 300 can process the event element 262. Such processing can include accessing and applying a rule data structure 310 to the event element 262. The entitlement computer system 210 may also provide event elements 262 to other computer systems, such as to the other source computer systems 270, or other computer systems not illustrated in FIG. 2. Such other computer systems may process events retrieved from the event queue 260 in different ways from each other.

The rule data structure 310 can be maintained by the notification computer system 300. Also, the rule data structure 310 may include a portion that is common to multiple different types of event elements 262 and/or multiple different entitled profiles 220. However, the notification computer system 300 may include a separate rule data structure 310, or at least a separate portion of the rule data structure 310 for each entitled profile 220. Such a rule data structure 310 may include preferences for a particular entitled profile 220 regarding how notifications are to be provided (or not provided) for changes to the entitlement record(s) 214 for that entitled profile 220. In one embodiment, the rule data structures 310 can be in the form of files or database records, such as in the form of extensible markup language (XML) files that can each be modified in response to user input from the corresponding entitled profile 220 (e.g., from the entitled profile 220 itself, or from one or more administrative sub-profiles 222 of the entitled profile 220).

The notification computer system 300 can generate a response to the detected event element 262, as governed by the rule data structure 310. For example, the notification computer system 300 may generate and send a notification 250 to the entitled profile 220, may instruct another computer system (e.g., the source computer system 270 (such as the entitlement computer system 210), the service provider computer system 230, or some other computer system) to send the notification 250 to the entitled profile 220, or may respond by declining to trigger a notification 250. In a case where a response is to refrain from sending a notification 250, a response to the event element 262 can be considered to be sent when the notification computer system 300 determines that a notification is not to be sent and provides an internal indication and/or an indication to another system that the processing of the event element 262 is complete. In any case, such responses can governed by the governing rule data structure 310 for the event element being processed.

The notification computer system 300 can maintain the entitled profiles 220, or those entitled profiles can be maintained in another system, such as the service provider computer system 230. Also, the notification computer system 300 can be separate from other computer systems, or it can be combined with one or more other computer systems discussed herein in some embodiments. Note that the notification computer system 300 can be considered separate from another system if it is running on different physical and/or virtual machines from the other system. Thus, the notification computer system 300 is considered to be separate from another system if the notification computer system 300 is hosted on the same physical computing machines but different virtual machines from the other system (such as in different virtual machines on the same physical machines in a cloud computer cluster). As an example of the notification computer being combined with another system, the notification computer system 300 may be a part of the service provider computer system 230 that provides the computer services to the entitled profiles 220.

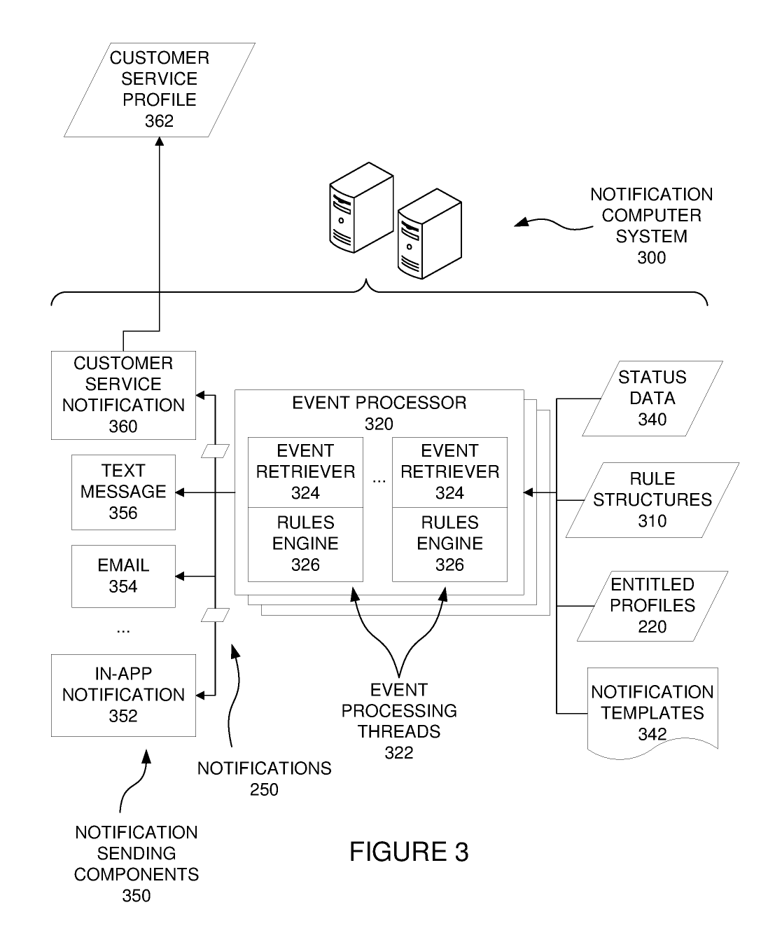

Referring now to FIGS. 2 and 3, a particular example of a notification computer system 300 will be discussed in more detail. The notification computer system 300 can include an event processor 320, which can be a running process in a computer application. The notification computer system 300 may be running multiple instances of the event processor 320, and those instances may be running in multiple separate virtual machines and/or in multiple separate physical machines, and possibly in multiple different geographic locations. Such multiple instances running at the same time in different operating environments can provide increased performance and reliability.

Each event processor 320 can include multiple event processing threads 322 running in parallel. Each event processing thread 322 can include an event retriever 324 and a rules engine 326. The event retriever 324 can monitor the event queue 260, detect event elements 262 in the event queue 260 and retrieve event elements 262 from the event queue 260. The event retriever 324 can do this by polling the event queue 260, which can be done by sending communications over the network 202 to the entitlement computer system 210. The entitlement computer system 210 can respond to each poll from an event retriever 324 by returning an event element 262 if one is available, or by informing the event retriever 324 that no event elements 262 are currently available in the event queue 260. If no event elements 262 are available, the event retriever 324 can continuously poll the event queue 260 until an event element 262 is returned in response to the polling. Alternatively, an event retriever 324 may pause for an amount of time before polling the event queue 260 again after being informed that no event elements 262 are available. As yet another alternative, the entitlement computer system 210 may provide event elements 262 to the notification computer system 300 as push notifications to allow the entitlement computer system 210 to monitor the event queue 260 and detect event elements 262, and the notification computer system 300 can distribute the event elements 262 to different parallel threads and/or processes as the event elements 262 are received. As another alternative scenario, each processing thread 322 can monitor the event queue 260 by subscribing to the event queue 260, and the entitlement computer system 210 can send each event element 262 to a particular subscribing event processing thread 322.

When an event retriever 324 retrieves an event element 262, the rules engine 326 in that thread can process the received event element 262. Of course, other configurations are possible. For example, each event retriever may be configured to continuously retrieve event elements 262 and pass those event elements 262 to rules engine threads that are spawned by the event retriever 324, so that each event retrieving thread may spawn multiple subsidiary rules engine threads that can process the event elements 262 in parallel with each other.

In processing an event element 262, the rules engine 326 can read the corresponding rule data structure 310 for that event element 262. For example, there may be a particular rule data structure 310 for the corresponding entitled profile 220. Thus, the rules engine 326 can apply rules such as customer preference rules to the processing of one or more notifications 250 for the received event element 262. The rules engine 326 may also apply general rules to streamline the providing of notifications 250. For example, if user input from the entitled profile 220 has indicated that only one notification per day (or per week, etc.) is to be sent, then the rules engine 326, possibly in conjunction with other rules engines 326 in other threads, may combine multiple notifications for multiple event elements 262 into a single notification 250. For example, the rules engine 326 for each thread may store an indication of the notification for corresponding event element 262 in a storage space, and each week (or some other period of time, such as each day, etc.), a process can retrieve all such notifications and include them in a single notification 250 that is sent to the entitled profile 220. As another example, a rule data structure 310 may dictate that a notification plan for the particular event element includes refraining from sending a notification to the entitled profile 220 for a particular received event element 262. In such a case, the rules engine 326 can respond by refraining from triggering a notification for that event element 262, and may send such a response to one or more components of the primary system 200 (such as by indicating that processing is complete without actually sending a notification 250).

Each event processing thread 322 may store its primary status data for ongoing processing of event elements 262 in the memory for the process of its event processor 320. Additionally, each event processing thread 322 may instruct status data 340 to be stored outside its process for failure recovery. Specifically, while processing the event elements 262, the event processors 320 can store status data 340, such as in a database table or other data structure. Such status data 340 can include status data for event elements 262 that are currently being processed. The status data 340 may also include status data for event elements 262 that have already been processed. For example, the status data 340 for already-processed-events may be included in an events log. The status data 340 may also be backed up to another storage site (not shown) to allow for recovery in the event of the failure of the storage for the status data 340. The notification computer system 300 can use the status data 340 to recover from failure of one or more of the event processing threads 322, such as where a single thread fails, an entire event processor 320 fails, or even where multiple event processors 320 fail.

Upon determining that a notification 250 is to be sent in response an event element 262 being processed (or possibly in response to multiple event elements 262 if notifications for multiple event elements 262 are to be combined into a single notification 250), an event processing thread 322 can access generate a notification 250. For example, the processing thread 322 can access and fill in a notification template 342. The particular template 342 for an event element 262 can be determined by the event processing thread 322 as governed by the selected rule data structure 310 for the corresponding event element 262. The event processing thread 322 can fill in blanks in the template using data from the event element 262. Such filled-in information may include address information for sending the notification, information about the type of event element 262 such as a type of change being made to a corresponding entitlement record 214, a date for the change being made, an identity of the entitled profile 220, and possibly other information such as a description of the type of service(s) to which the entitled profile 220 is entitled.

The event processing thread 322 can send the filled-in template to a notification sending component 350, and that sending component 350 can process and send out the notification 250. Each notification sending component 350 can include infrastructure for sending a particular type of notification 250. For example, the notification sending components 350, may include an in-application notification component 352, which can send a notification 250 to an entitled profile 220 by inserting the notification 250 in a user interface of an application being used by the entitled profile 220 (such as an application that is active in an environment where the entitled profile 220 (or a sub-profile) is logged in). Similarly, the notification sending components 350 can include an email sending component 354 and a text message sending component 356. Other sending components could also be utilized, such as an automated telephone calling component.

The notification sending components 350 can also include a customer service notification component 360. The customer service notification component 360 can send the notification to the entitled profile 220 indirectly by sending a notification to a customer service profile 362, instructing the customer service profile 362 to notify the entitled profile 220. That customer service profile 362 can respond by sending a notification to the entitled profile 220. Such sending by the customer service profile 362 may be a partially or fully automated response to the notification from the customer service notification component 360. For example, a customer service profile 362 may automatically send an email or text message to the entitled profile 220, or it may automatically place a call to the entitled profile 220. A customer service personnel user may be involved in this sending to the user. For example, the notification that is sent to the customer service profile 362 may request that a user of the customer service profile 362 initiate the notification to the entitled profile 220 by providing user input to a computer system to place a call or otherwise send a notification 250 to the entitled profile 220.

Note that in this situation of the customer service notification component 360, the notification from the customer service notification component 360 to the customer service profile 362, instructing that customer service profile 362 to send a notification to the entitled profile 220, can be considered to be the sending of the notification 250 to the entitled profile 220. Indeed, the processing thread 322 sending a notification to any of the notification sending components 350 can be considered to be the sending by the processing thread 322 of the notification 250 to the entitled profile 220, because the notification is being sent with computer-readable instructions to provide the notification to the entitled profile 220. The primary system 200 responds to such notifications 250 by delivering the notifications to the appropriate entitled profile 220 at one or more client computer devices 240. Also, the notification sending components 350 may be located inside or outside the notification computer system 300.

After a processing thread 322 sends the notification 250 in response to retrieving an event element 262, the processing thread can send an instruction to the entitlement computer system 210, instructing the entitlement computer system 210 to mark the event element 262 as completed, and possibly also instructing the entitlement computer system to remove the completed event element 262 from the event queue 260.

The event processors 320 may be scalable in response to user input that instructs the notification computer system 300 to include more or fewer event processors 320 and/or more or fewer event processing threads 322. Also, at least some such scalability may be automatically performed. For example, the notification computer system 300 may be configured to initiate additional instances of event processors 320 in one or more environments such as additional virtual machine environments, in response to detecting that all the event processing threads 322 are currently busy processing event elements 262, or detecting that some predetermined percentage or number of the event processing threads 322 are currently busy processing event elements 262. Similarly, if some predetermined number or percentage of event processing threads 322 are not busy processing event elements 262, the notification computer system 300 may automatically reduce the number of event processors 320 by cancelling one or more instances. In the same manner, within a particular event processor 320, the notification computer system 300 may alter the number of event processing threads 322 in response to a percentage or number of processing threads that are currently busy processing event elements 262. In addition to or instead of using the percentage or number of busy processing threads, other measures of loads on the notification computer system 300 may also be used to determine whether to add or decrease the number of event processors 320 and/or the number of event processing threads 322 per event processor 320. For example, the notification computer system 300 may consider the time lag for processing each event element 262. Additionally, such measures of the load on the notification computer system 300 may be calculated in different determination operations, such as by averaging a measured value over a period of time and including a decay function that decreases the impact of older values on the determined average.

The notification computer system 300 can also process event elements 262 from other source computer systems 270 in addition to the event elements 262 from the entitlement computer system 210. Those event elements 262 may be processed by the notification computer system 300 in the same manner as the event elements 262 from the entitlement computer system 210. Also, for one or more of the source computer systems 270, the sending of the notifications 250 to the corresponding entitled profile 220 may include sending the notifications 250 as dictated by the governing rule data structure 310 via the source computer system 270 from which the event elements 262 were received, and/or via some other computer system.

While the primary entitlement change notification system 200 is described herein with reference to a particular implementation, other implementations could be used. For example, each event processor 320 could include only a single thread. Also, a single event retriever could be configured to spawn multiple rules engine processes or threads to process event elements 262 retrieved by that event retriever. Of course, many other different configurations of the primary system 200 (including its subsystems) could be used.

### III. Rule-Governed Entitlement Change Notification Techniques

Multiple rule-governed entitlement change notification techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic.

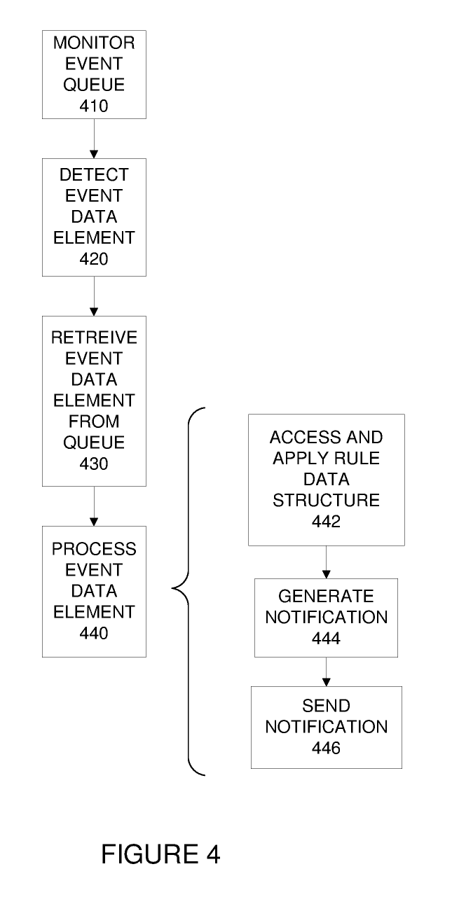

Referring to FIG. 4, a rule-governed entitlement change notification technique will be described. The technique can be performed via a primary computer system, which can include a notification compute system. The technique can include monitoring 410 computer-readable event data elements in an event queue of an entitlement computer system that is separate from the notification computer system. The technique can also include detecting 420 an event data element in the event queue. The event data element can represent a notification of a change to an entitlement data record in a computer-readable entitlement data structure of the entitlement computer system. The entitlement data structure can include computer-readable entitlement records of entitlements of one or more computer-readable entitled profiles to a computer service. The entitlement data record can be a record of an entitlement of a computer-readable entitled profile to the computer service. The technique of FIG. 4 can further include retrieving 430 the event data element from the event queue.

Additionally, the technique can include processing 440 the event data element in response to the detecting of the event data element in the event queue. The processing 440 can include accessing and applying 442 a computer-readable rule data structure that governs processing of events from the event queue. The processing 440 can also include generating 444 a notification in a manner dictated by the rule data structure, with the notification indicating the change to the data structure represented by the event data element. The processing 440 of the event data element may also include sending 446 the notification to the entitled profile. The technique may further include presenting the notification on a client computing device, such as by displaying the notification on a computer device display and/or audibly reading the notification with computer device speakers. The technique of FIG. 4 may also include various different features discussed in the following paragraphs regarding additional details and features of the technique of FIG. 4 in combination with one or more of the other features in such paragraphs.

The acts discussed in the preceding paragraph may be performed by a notification computer system and additional acts may be performed by another separate computer system, such as an entitlement computer system, that is also part of the primary computer system. Such acts may include maintaining the computer-readable entitlement data structure, and maintaining the event queue. The acts performed by the entitlement computer system may also include performing the following as a real time response to a change to the entitlement data structure that reflects a change in the entitlement: detecting the change to the entitlement data structure; and inserting the event data element in the event queue.

The acts of the entitlement computer system may further include providing data about changes in the event queue to a plurality of separate computer systems, with the plurality of separate computer systems including the notification system. Also, the detecting of the event data element in the event queue and the processing of the event data element can be performed as a real time response to the change to the entitlement data structure that reflects the change in the entitlement data record. The detecting of the event data element in the event queue and the processing of the event data element may also be performed as a real time response to the event data element appearing in the event queue.

In the technique of FIG. 4, the change to the entitlement data record can include a change to the entitlement data record to indicate that the entitlement represented by the entitlement data record is activated, deactivated, scheduled to be deactivated at a specified time, or some other entitlement lifecycle change represented in the entitlement data record.

The computer-readable rule data structure that governs processing of events from the event queue comprises profile preferences for processing of events (e.g., preferences for what types of changes trigger notifications being sent to the entitled profile, what types of notifications are to be sent to the entitled profile, how often notifications are to be sent to the entitled profile, etc.), with the profile preferences being different from one entitled profile to another entitled profile. The acts may further include receiving computer-readable user input from the entitled profile indicating a preference for processing of events for the entitled profile; and changing the rule data structure in accordance with the user input to indicate the preference. The processing of the event data element can include processing the event data element in a specified manner dictated by the preference of the user input.

The monitoring 410 of the event data elements can include repeatedly polling the entitlement computing system for data representing a status of the event queue, such as by repeatedly sending information requests to the entitlement computing system and receiving corresponding responses back from the entitlement computing system in response to the requests. The responses may include various types of information. For example, the responses may simply indicate whether events are present in the event queue (in which case follow-up requests may be sent if events are present in the queue), the responses may include information about events present in the event queue (in which case follow-up requests may be sent if events are present in the queue), and the responses may include the actual events from the event queue.

The rule data structure for the technique of FIG. 4 may include different types of settings or other data governing the processing of the events from the event queue. For example, the rule data structure may dictate a notification type for the event data element from among a plurality of available notification types, and the resulting notification can be of the notification type. The rules may identify particular sub-profiles that are to receive notifications for a corresponding entitled profile. The rules may dictate how multiple different notifications may be bundled together and sent as a single notification (e.g., one notification per day, one notification per week, etc.). In sum, the rule data structure may dictate any combination of these and/or other rules to govern the generation and sending of messages in response to the events.

The sending 446 of the notification to the entitled profile can include notifying a computer-readable customer service profile of the event data element, and instructing the computer-readable customer service profile to contact the entitled profile regarding the event data element.

The rule data structure may dictate refraining from sending a notification in response to an event. For example, where the event data element is a first event data element, the acts of the technique of FIG. 4 may further include detecting a second event data element in the event queue, with the second event data element representing a notification of a change to the entitlement data record in the computer-readable entitlement data structure of the entitlement computer system. The second event data element may be retrieved from the event queue. In response to this detecting, the acts can include processing the second event data element. This processing can include accessing the computer-readable rule data structure and applying the computer-readable rule data structure to the second event data element. The accessing and applying can include determining that the rule data structure dictates that a notification is not to be sent to the entitled profile for the second event data element. In response to this determination, the notification system can refrain from sending a notification of the second event data element to the entitled profile.

The acts of FIG. 4 may further include receiving event data elements from a plurality of separate source computer systems, and in response for each received event data element, processing the event data element according to the rule data structure. The processing of each event data element from the source computer system can include the following: accessing the computer-readable rule data structure; applying the computer-readable rule data structure to the event data element from the source computer system; generating a response to the event data element from the source computer system, with the response being dictated by the rule data structure, and with the response dictating a notification plan regarding a notification representing the event data element from the source computer system; and sending the response.

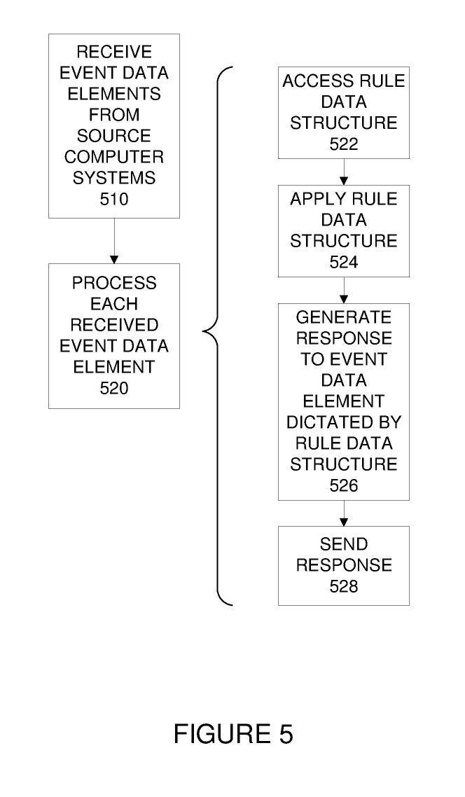

Referring now to FIG. 5, another rule-governed entitlement change notification technique will be described. The technique can be performed by a notification computer system. The technique can include receiving 510 event data elements from a plurality of separate source computer systems that are separate from the notification computer system, with the source computer systems comprising an entitlement computer system. In response to such receiving, the technique can include processing 520 each event data element according to a computer-readable rule data structure that governs the processing of the event data elements, with each event data element indicating a change to a data structure represented by the event data element. One or more of the event data elements can represent a change to a computer-readable entitlement record in an entitlement data structure in the entitlement computer system. The processing 520 of the event data elements can include the following for each event data element: accessing 522 the computer-readable rule data structure; applying 524 the computer-readable rule data structure to the event data element; generating 526 a response to the event data element dictated by the rule data structure, with the response dictating a notification plan regarding a notification of an entitlement lifecycle event represented by the event data element; and sending 528 the response. The notification plan can be computer-readable data that indicates the parameters of the notification response to the event data element, as dictated by the application of the rule data structure to the event data element, such as whether to send a notification for the event data element, what to include in the notification, how to send the notification, when to send the notification, to what user profile (such as a sub-user profile) to send the notification, what type of notification to send, and so forth. Such a plan can be stored in memory, such as in memory for a process of an event processor, as discussed above with reference to FIGS. 2-3. The technique of FIG. 5 may also include various different features discussed in the following paragraphs regarding additional details and features of the technique of FIG. 5 in combination with one or any combination of the other features in such paragraphs.

In the technique of FIG. 5, an entitlement event data element of the event data elements can represent a lifecycle change to a computer-readable entitlement of an entitled profile to a computer service. Also, sending 528 the response to the entitlement event data element can include sending a notification to the entitled profile regarding the change to the entitlement.

In the technique of FIG. 5, an entitlement event data element of the event data elements can represent a change to a computer-readable entitlement record representing an entitlement of a computer-readable entitled profile to a computer service. The entitlement event data element may be an element from the entitlement computer system. The response can dictate sending an instruction to a customer service profile, with the instruction requesting one or more customer service personnel to contact the entitled profile.

Additionally, an entitlement event data element of the event data elements can represent a change to a computer-readable entitlement of an entitled profile to a computer service, and the response to the entitlement event data element can dictate that no notification is to be provided to the entitled profile in response to the entitlement event data element.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. An primary computer system comprising:
at least one processor; and
memory comprising instructions stored thereon that when executed by at least one processor cause at least one processor of a notification computer system in the primary computer system to perform acts comprising:
monitoring computer-readable event data elements in an event queue of an entitlement computer system that is separate from the notification computer system;
detecting an event data element in the event queue, the event data element representing a notification of a change to an entitlement data record in a computer-readable entitlement data structure of the entitlement computer system, the entitlement data structure comprising computer-readable entitlement records of entitlements of one or more computer-readable entitled profiles to a computer service, and the entitlement data record being a record of an entitlement of a computer-readable entitled profile to the computer service;
retrieving the event data element from the event queue;
in response to the detecting of the event data element in the event queue, processing the event data element, the processing comprising:
accessing and applying a computer-readable rule data structure that governs processing of events from the event queue;
generating a notification in a manner dictated by the rule data structure, the notification indicating the change to the data structure represented by the event data element; and
sending the notification to the entitled profile.

2. The primary computer system of claim 1, wherein the acts are notification system acts, the primary computer system further comprises the entitlement computer system, and the memory further comprises instructions stored thereon that when executed by at least one processor cause at least one processor of the entitlement computer system to perform entitlement system acts comprising:
maintaining the computer-readable entitlement data structure;
maintaining the event queue;
performing the following as a real time response to a change to the entitlement data structure that reflects a change in the entitlement:
detecting the change to the entitlement data structure; and
inserting the event data element in the event queue.

3. The primary computer system of claim 2, wherein the entitlement computer system acts further comprise providing data about changes in the event queue to a plurality of separate computer systems, the plurality of separate computer systems including the notification system.

4. The primary computer system of claim 2, wherein the detecting of the event data element in the event queue and the processing of the event data element are performed as a real time response to the change to the entitlement data structure that reflects the change in the entitlement data record.

5. The primary computer system of claim 1, wherein the detecting of the event data element in the event queue and the processing of the event data element are performed as a real time response to the event data element appearing in the event queue.

6. The primary computer system of claim 1, wherein the change to the entitlement data record comprises a change to the entitlement data record to indicate that the entitlement represented by the entitlement data record is activated.

7. The primary computer system of claim 1, wherein the change to the entitlement data record comprises a change to the entitlement data record to indicate that the entitlement represented by the entitlement data record is deactivated.

8. The primary computer system of claim 1, wherein the change to the entitlement data record comprises a change to the entitlement data record to indicate that the entitlement represented by the entitlement data record is scheduled to be deactivated at a specified time.

9. The primary computer system of claim 1, wherein the computer-readable rule data structure that governs processing of events from the event queue comprises profile preferences for processing of events, with the profile preferences being different from one entitled profile to another entitled profile.

10. The primary computer system of claim 9, wherein the acts further comprise:
receiving computer-readable user input from the entitled profile indicating a preference for processing of events for the entitled profile; and
changing the rule data structure in accordance with the user input to indicate the preference, wherein the processing comprises processing the event data element in a specified manner dictated by the preference of the user input.

11. The primary computer system of claim 1, wherein the monitoring of the event data elements comprises repeatedly polling the entitlement computing system for data representing a status of the event queue.

12. The primary computer system of claim 1, wherein the rule data structure dictate a notification type for the event data element from among a plurality of available notification types, and wherein the notification is the notification type.

13. The primary computer system of claim 1, wherein the sending of the notification to the entitled profile comprises notifying a computer-readable customer service profile of the event data element, and instructing the computer-readable customer service profile to contact the entitled profile regarding the event data element.

14. The primary computer system of claim 1, wherein the event data element is a first event data element, and the acts further comprise:
detecting a second event data element in the event queue, the second event data element representing a notification of a change to the entitlement data record in the computer-readable entitlement data structure of the entitlement computer system;
retrieving the second event data element from the event queue;
in response to the detecting of the second event data element in the event queue, processing the second event data element, the processing of the second event data element comprising:
accessing and applying the computer-readable rule data structure to the second event data element, the accessing and applying to the second event data element comprising determining that the computer-readable rule data structure dictates that a notification is not to be sent to the entitled profile for the second event data element; and
in response to the determining, refraining from sending a notification of the second event data element to the entitled profile.

15. The primary computer system of claim 1, wherein the acts further comprise:
receiving event data elements from a plurality of separate source computer systems;
in response to the receiving of each event data element from the source computer systems, processing the event data element from a source computer system according to the computer-readable rule data structure, with the processing of each event data element from the source computer system comprising the following:
accessing the computer-readable rule data structure;
applying the computer-readable rule data structure to the event data element from the source computer system;
generating a response to the event data element from the source computer system, with the response being dictated by the rule data structure, and with the response dictating a notification plan regarding a notification representing the event data element from the source computer system; and
sending the response.

16. A primary computer system comprising:
at least one processor; and
memory comprising instructions stored thereon that when executed by at least one processor cause at least one processor of a notification computer system in the primary computer system to perform acts comprising:
receiving event data elements from a plurality of separate source computer systems that are separate from the notification computer system, the source computer systems comprising an entitlement computer system;
in response to the receiving of each event data element, processing the event data element according to a computer-readable rule data structure that governs the processing of the event data elements, with each event data element indicating a change to a data structure represented by the event data element, with one or more of the event data elements representing a change to a computer-readable entitlement record in an entitlement data structure in the entitlement computer system, and with the processing of the event data elements comprising the following for each event data element:
accessing the computer-readable rule data structure;
applying the computer-readable rule data structure to the event data element;
generating a response to the event data element dictated by the rule data structure, the response dictating a notification plan regarding a notification of an entitlement lifecycle event represented by the event data element; and
sending the response.

17. The primary computer system of claim 16, wherein an entitlement event data element of the event data elements represents a lifecycle change to a computer-readable entitlement of an entitled profile to a computer service, and wherein the response to the entitlement event data element comprises sending a notification to the entitled profile regarding the change to the entitlement.

18. The primary computer system of claim 16, wherein an entitlement event data element of the event data elements represents a change to a computer-readable entitlement record representing an entitlement of a computer-readable entitled profile to a computer service, wherein the entitlement event data element came from the entitlement computer system, and wherein the response dictates sending an instruction to a customer service profile, the instruction requesting one or more customer service personnel to contact the entitled profile.

19. The primary computer system of claim 16, wherein an entitlement event data element of the event data elements represents a change to a computer-readable entitlement of an entitled profile to a computer service, and wherein the response to the entitlement event data element dictates that no notification is to be provided to the entitled profile in response to the entitlement event data element.

20. A computer-implemented method comprising:
monitoring, via a notification computer system, computer-readable event data elements in an event queue of an entitlement computer system that is separate from the notification computer system;
detecting, via the notification computer system, an event data element in the event queue, the event data element representing a notification of a change to an entitlement data record in a computer-readable entitlement data structure of the entitlement computer system, the entitlement data structure comprising computer-readable entitlement records of one or more computer-readable entitled profiles to a computer service, and the entitlement data record being a record of an entitlement of a computer-readable entitled profile to the computer service;
retrieving, via the notification computer system, the event data element from the event queue;
in response to the detecting of the event data element in the event queue, processing the event data element via the notification computer system, the processing comprising:
accessing and applying a computer-readable rule data structure that governs the processing of events from the event queue;
generating a notification in a manner dictated by the rule data structure, the notification indicating the change to the data structure represented by the event data; and
sending the notification to the entitled profile.
